(19) United States
(12) Patent Application Publication
(10) Pub. No.: US 2025/0222424 A1
(43) Pub. Date: Jul. 10, 2025

(54) FULL-AUTOMATIC RADIOPHARMACEUTICAL PRODUCTION APPARATUS

(71) Applicant: SUNMAO MEDICAL TECHNOLOGIES CO., LTD., Wuxi (CN)

(72) Inventors: Shanyou YU, Wuxi (CN); Xuan LV, Wuxi (CN); Peng FANG, Wuxi (CN); Wai-si ENG, Wuxi (CN); Chenglong YAN, Wuxi (CN)

(21) Appl. No.: 19/093,318

(22) Filed: Mar. 28, 2025

Related U.S. Application Data
(63) Continuation of application No. PCT/CN2023/115591, filed on Aug. 29, 2023.

(30) Foreign Application Priority Data
Sep. 30, 2022 (CN) 202222621648.3

(51) Int. Cl. B01J 19/00

(52) U.S. Cl. CPC B01J 19/0053; B01J 2219/00076; B01J 2219/00337; B01J 2219/00353; B01J 2219/00686; B01J 2219/00759

(57) ABSTRACT

Provided is a full-automatic radiopharmaceutical production apparatus including a synthesis device. The synthesis device includes a synthesis cassette and a main synthesis unit. The synthesis cassette includes a synthesis cassette body. The synthesis cassette body includes a first common pipe extending in a left-right direction. The first common pipe is located between three-way valves that are adjacent in the left-right direction. The main synthesis unit includes a main synthesis unit frame. The first common pipe is detachably fixed at a front housing of the main synthesis unit frame by a first fixing assembly.

### CROSS-REFERENCE TO RELATED APPLICATION

This application is a continuation of International Patent Application No. PCT/CN2023/115591, filed on Aug. 29, 2023, which is based on and claims priority to Chinese patent application No. 202222621648.3 filed on Sep. 30, 2022, the entire contents of which are incorporated herein by reference.

### FIELD

The present disclosure relates to the field of radiopharmaceutical production technologies, and particularly, to a full-automatic radiopharmaceutical production apparatus.

### BACKGROUND

In a conventional full-automatic radiopharmaceutical production apparatus, mounting and fixation between a disposable cassette and a main unit are relatively scattered, which results in inconvenient mounting, complex wiring, and relatively difficult disassembly.

### SUMMARY

The present disclosure aims to solve at least one of the technical problems in the related art. To this end, an objective of the present disclosure is to provide a full-automatic radiopharmaceutical production apparatus, in which mounting and disassembly between the synthesis cassette and the main synthesis unit are quick and easy.

According to an embodiment of the present disclosure, a full-automatic radiopharmaceutical production apparatus includes a synthesis device. The synthesis device includes: a synthesis cassette including a synthesis cassette body, the synthesis cassette body including a first common pipe extending in a left-right direction, the first common pipe being located between three-way valves that are adjacent in the left-right direction; and a main synthesis unit including a main synthesis unit frame, the first common pipe being detachably fixed at a front housing of the main synthesis unit frame by a first fixing assembly.

In the full-automatic radiopharmaceutical production apparatus according to the embodiment of the present disclosure, the first common pipe of the synthesis cassette is detachably fixed to the front housing of the main synthesis unit frame by the first fixing assembly, in such a manner that the synthesis cassette can be conveniently fixed to the main synthesis unit. Therefore, mounting is fast, reliable, intuitive, and convenient, and replacement is easy.

In some embodiments, the first fixing assembly is one of a mounting sleeve, a snapping hook assembly, and an engagement assembly.

In some embodiments, the first common pipe is detachably engaged with and fixed at an inner side of the mounting sleeve; and the mounting sleeve is detachably inserted into and fixed at the front housing.

In some embodiments, the mounting sleeve includes: a vertical plate, the vertical plate and the front housing facing each other; and an engagement base fixed at a rear side surface of the vertical plate, the first common pipe being engaged in the engagement base.

In some embodiments, the engagement base includes an upper engagement base and a lower engagement base, the first common pipe being engaged between the upper engagement base and the lower engagement base.

In some embodiments, the mounting sleeve further includes a three-way valve support fixed at the rear side surface of the vertical plate, the three-way valve support being configured to support a corresponding one of the three-way valves at the first common pipe.

In some embodiments, the mounting sleeve further includes a surrounding wall located at a rear side of the vertical plate, the surrounding wall having an end fixed to a periphery of the vertical plate and another end provided with a plurality of insertion portions, the plurality of insertion portions being adaptively inserted into and fixed to the front housing.

In some embodiments, the front housing is provided with a first support, a bottom of the surrounding wall being supported on the first support.

In some embodiments, a top of the surrounding wall has a plurality of through holes for passage of respective containers and respective tubes at the synthesis cassette body.

In some embodiments, the snapping hook assembly is disposed at the front housing and configured to hook and snap at the first common pipe in a front-rear direction.

In some embodiments, the snapping hook assembly includes a snapping hook located at an outer side of the front housing, the snapping hook including a hook portion at a front end of the snapping hook, the hook portion being configured to hook and snap at the first common pipe.

In some embodiments, the snapping hook assembly further includes a first spring vertically arranged at a rear side of the front housing, the first spring having an end fixed at the front housing and another end fixed at a rear end of the snapping hook, and the first spring being configured to, by means of a restoring force of the first spring, enable the hook portion to hook and snap at the first common pipe; and the snapping hook passes through the front housing and is disposed on the front housing to be rotatable up and down about an axis.

In some embodiments, the hook portion faces downwards; and the restoring force of the first spring acts vertically upwards.

In some embodiments, the snapping hook is provided with coaxial rotation shafts at a left side and a right side of the snapping hook, respectively, each of the rotation shafts being rotatably mounted at an inner side of the front housing.

In some embodiments, the snapping hook assembly further includes a protective sleeve fixed at a front side of the front housing, the protective sleeve having a space for the snapping hook to rotate up and down, the snapping hook being located in the space, and the hook portion extending out of the protective sleeve.

In some embodiments, the synthesis cassette body further includes a foundation base located below the synthesis cassette body, the synthesis cassette body being fixed at the foundation base; and the front housing is provided with a second support, the foundation base being supported on the second support.

In some embodiments, a top of the second support has an engagement groove, a lower end of the foundation base being engaged in the engagement groove.

In some embodiments, the main synthesis unit further includes a barrel fixing module disposed at the front housing and including a first engagement block and a second engagement block, the first engagement block and the second engagement block being arranged to face each other in the left-right direction and configured to tightly clamp a barrel of a syringe at the synthesis cassette body, and a distance between the first engagement block and the second engagement block being adjustable.

In some embodiments, the barrel fixing module further includes a second spring. The first engagement block is fixed at the front housing. The second engagement block is arranged at the front housing to be movable in the left-right direction. Each of an engagement portion of the first engagement block and an engagement portion of the second engagement block is located at a front side of the front housing. The second spring has an end connected to the second engagement block and another end fixed to the front housing, the second spring being configured to, by means of a restoring force of the second spring, enable the engagement portion of the second engagement block and the engagement portion of the first engagement block to tightly clamp the barrel of the syringe at the synthesis cassette body.

In some embodiments, the main synthesis unit further includes a container fixing module disposed at the front housing and having a plurality of fixing cavities, the plurality of fixing cavities being configured to correspondingly accommodate a barrel of a syringe and a container at the synthesis cassette body.

In some embodiments, the main synthesis unit further includes a heating system including a heater and a heat insulation plate, the heater being fixed at a front side of the front housing, and the heat insulation plate being arranged between the front housing and the heater.

In some embodiments, the heat insulation plate has a thickness ranging from 1 mm to 10 mm.

In some embodiments, the main synthesis unit further includes a heat dissipation system having a heat dissipation channel and including a heat dissipation device, the heat dissipation channel and the heat dissipation device being disposed in the main synthesis unit frame, and the heat dissipation channel having an end connected to the heater and another end connected to the heat dissipation device.

In some embodiments, the main synthesis unit further includes a radioactive probe fixed at a rear side of the front housing, the radioactive probe being selectively arranged to face a container or a syringe at the synthesis cassette body in a front-rear direction.

In some embodiments, a distance between the radioactive probe and the container or the syringe ranges from 1 mm to 100 mm.

In some embodiments, the main synthesis unit further includes an anti-corrosion surface disposed at a front surface of the front housing, the anti-corrosion surface being located between the front housing and the synthesis cassette.

In some embodiments, the full-automatic radiopharmaceutical production apparatus further includes at least one of a purification device or a waste gas treatment device.

In some embodiments, the purification device includes: a purification cassette body including a second common pipe extending in the left-right direction, where the purification cassette body and the synthesis cassette body are detachably connected to receive a radiopharmaceutical produced by the synthesis device; and a main purification unit independently provided and including a main purification unit frame, the second common pipe being detachably fixed at the main purification unit frame by a second fixing assembly.

In some embodiments, the waste gas treatment device includes a waste gas treatment device frame, a three-way solenoid valve, a washing bottle, a U-shaped tube, and a vacuum pump. The waste gas treatment device frame is independently provided. Each of the three-way solenoid valve, the washing bottle, the U-shaped tube, and the vacuum pump is mounted in the waste gas treatment device frame. The three-way solenoid valve has an end detachably connected to an outlet pipe of a waste gas bottle of the synthesis cassette body and another end connected to the washing bottle. The U-shaped tube has an end connected to the washing bottle and another end connected to the vacuum pump.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a principle view of a synthesis system, a purification system, and a waste gas treatment system in a full-automatic radiopharmaceutical production apparatus according to an embodiment of the present disclosure.

FIG. 2 is a perspective view of a synthesis device according to an embodiment of the present disclosure.

FIG. 3 is a schematic view of a mounting sleeve at a synthesis device according to an embodiment of the present disclosure.

FIG. 4 is a schematic view of another synthesis device according to an embodiment of the present disclosure.

FIG. 5 is a schematic internal structure view of another synthesis device according to an embodiment of the present disclosure, viewed from a perspective.

FIG. 6 is a perspective view of a main synthesis unit of another synthesis device according to an embodiment of the present disclosure.

FIG. 7 is a partial structural view of a synthesis cassette at another synthesis device according to an embodiment of the present disclosure.

FIG. 8 is a schematic view of a snapping hook at another synthesis device according to an embodiment of the present disclosure.

FIG. 9 is a schematic view of mounting sites of a first spring and a second spring at another synthesis device according to an embodiment of the present disclosure.

FIG. 10 is a schematic view of a protective sleeve and a snapping hook at another synthesis device according to an embodiment of the present disclosure.

FIG. 11 is a schematic view of a barrel fixing module at another synthesis device according to an embodiment of the present disclosure.

FIG. 12 is a schematic internal structure view of another synthesis device according to an embodiment of the present disclosure, viewed from another perspective.

FIG. 13 is a schematic cross-sectional view of another synthesis device according to an embodiment of the present disclosure.

FIG. 14 is a perspective view of a purification device according to an embodiment of the present disclosure.

FIG. 15 is an internal structure view of a purification device according to an embodiment of the present disclosure.

FIG. 16 is a front view of a purification device according to an embodiment of the present disclosure.

FIG. 17 is a cross-sectional view taken along line A-A in FIG. 16.

FIG. 18 is a perspective view of a waste gas treatment device according to an embodiment of the present disclosure.

FIG. 19 is an internal structure view of a waste gas treatment device according to an embodiment of the present disclosure.

### REFERENCE NUMERALS OF THE ACCOMPANYING DRAWINGS

synthesis device 1; synthesis cassette 101; synthesis cassette body 1011; multi-linked three-way module 1011a; first common pipe 10111; three-way valve 10112; foundation base 1012; main synthesis unit 102; main synthesis unit frame 1021; front housing 10211; first support 10211a; first spring fixing block 102111; second spring fixing block 102112; second support 10211b; engagement groove 10211c; rotary motor drive assembly 1022; linear motor drive assembly 1023; barrel fixing module 1024; first engagement block 10241; second engagement block 10242; second spring 10243; container fixing module 1025; fixing cavity 10251; heating system 1026; heater 10261; heat insulation plate 10262; heat dissipation system 1027; heat dissipation channel 10271; heat dissipation device 10272; radioactive probe 1028; anti-corrosion surface 1029;
purification device 2; purification cassette 201; purification cassette body 2011; second common pipe 20111; main purification unit 202; main purification unit frame 2021;
waste gas treatment device 3; waste gas treatment device frame 301; three-way solenoid valve 302; washing bottle 303; U-shaped tube 304; vacuum pump 305;
first fixing assembly 5; mounting sleeve 501; vertical plate 5011; engagement base 5012; upper engagement base 5012a; lower engagement base 5012b; recess 5012c; three-way valve support 5013; surrounding wall 5014; insertion portion 5015; through hole 50141; snapping hook assembly 502; snapping hook 5021; rotary shaft 50211; protective sleeve 5022;
second fixing assembly 6;
synthesis system M; purification system N; waste gas treatment system L.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

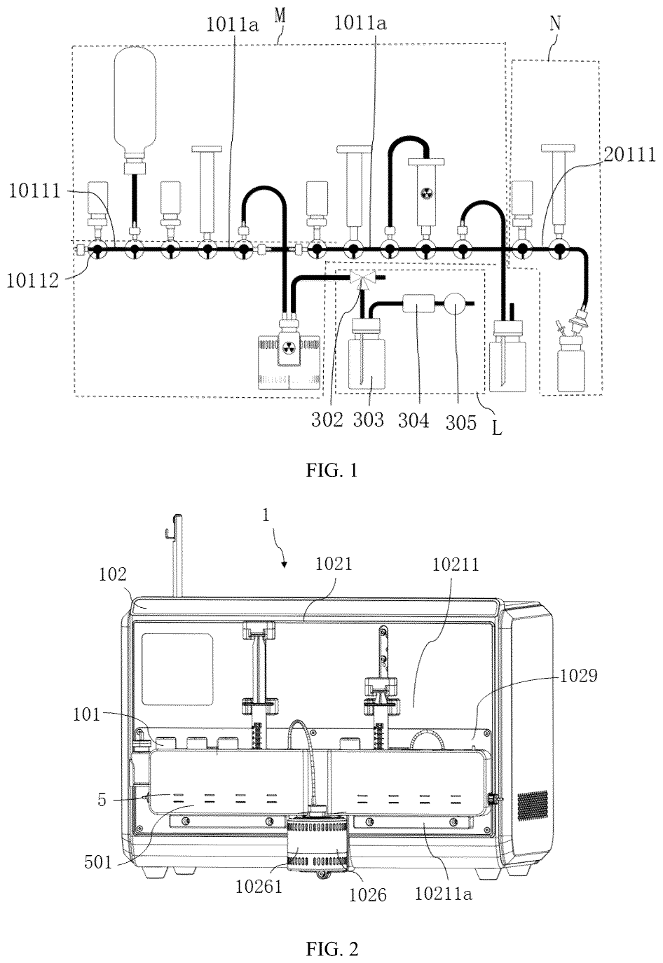

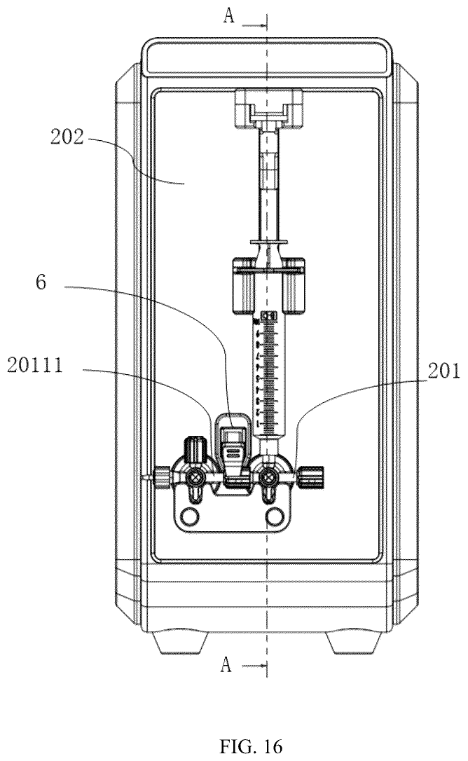

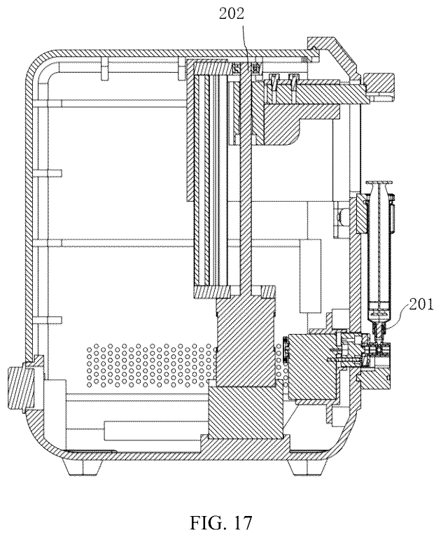

A full-automatic radiopharmaceutical production apparatus according to the embodiments of the present disclosure is described below in conjunction with FIG. 1 to FIG. 19.

As illustrated in FIG. 1 to FIG. 13, the full-automatic radiopharmaceutical production apparatus according to the embodiments of the present disclosure includes a synthesis device 1. The synthesis device 1 includes a synthesis cassette 101 and a main synthesis unit 102. The synthesis cassette 101 includes a synthesis cassette body 1011. The synthesis cassette body 1011 includes a first common pipe 10111 extending in a left-right direction. The first common pipe 10111 is located between three-way valves 10112 that are adjacent in the left-right direction. The main synthesis unit 102 includes a main synthesis unit frame 1021. The first common pipe 10111 is detachably fixed at a front housing 10211 of the main synthesis unit frame 1021 by a first fixing assembly 5 (see FIG. 2 and FIG. 4).

Specifically, the synthesis cassette 101 includes the synthesis cassette body 1011. The synthesis cassette body 1011 can be understood as a synthesis system M in FIG. 1, and is a main component of the synthesis cassette 101. Radiopharmaceutical labeling and synthesis are carried out in the synthesis cassette body 1011, which is a disposable product. The synthesis cassette body 1011 includes the first common pipe 10111 extending in the left-right direction. As illustrated in FIG. 1, the synthesis cassette body 1011 is mainly composed of a multi-linked three-way module 1011a, a syringe, a container, and a tube. The multi-linked three-way module 1011a includes a plurality of three-way valves 10112 and the first common pipe 10111 extending in the left-right direction. The plurality of three-way valves 10112 are sequentially arranged at the first common pipe 10111. A right port of the three-way valve 10112 at a left side of two three-way valves 10112 that are adjacent to each other in the left-right direction is in communication with a left port of the three-way valve 10112 at a right side of the two three-way valves 10112 that are adjacent to each other in the left-right direction through the first common pipe 10111. That is, the first common pipe 10111 refers to a pipe, in the multi-linked three-way module 1011a, connected between the three-way valves 10112 that are adjacent. The multi-linked three-way module 1011a, the syringe, and the container are in communication with each other through the tube in accordance with a flow path required for liquid transfer during a radiopharmaceutical labeling and synthesis process operation, forming an integral synthesis cassette body 1011.

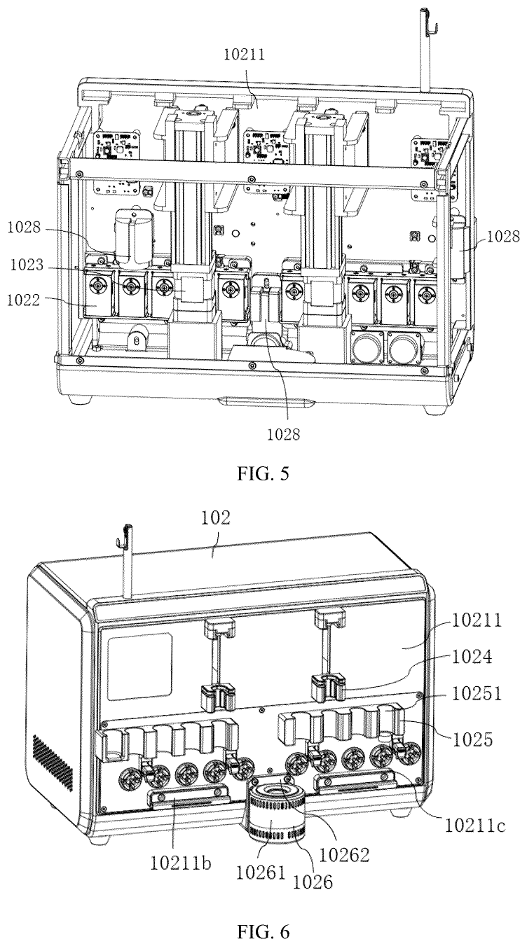

The main synthesis unit 102 includes the main synthesis unit frame 1021. For example, as illustrated in FIG. 2 and FIG. 4, the main synthesis unit frame 1021 is composed of the front housing 10211, a rear housing, a left housing, a right housing, a bottom plate, and a top plate. As illustrated in FIG. 5, a rotary motor drive assembly 1022, a linear motor drive assembly 1023, and other functional components are mounted in the main synthesis unit frame 1021. As illustrated in FIG. 4 and FIG. 5, the rotary motor drive assembly 1022 is connected to the three-way valve 10112 at the synthesis cassette 101 to control a state of communication of a left port, an upper port, and a lower port of the three-way valve 10112 at the synthesis cassette 101. The linear motor drive assembly 1023 is connected to a piston of the syringe at the synthesis cassette 101 to control up and down movements of the piston. As illustrated in FIG. 2 and FIG. 4, the first common pipe 10111 is detachably fixed at the front housing 10211 of the main synthesis unit frame 1021 by the first fixing assembly 5. That is, the synthesis cassette body 1011 is fixed to the front housing 10211 in such a manner that the first fixing assembly 5 is detachably connected to the first common pipe 10111 and the first fixing assembly 5 is connected to the front housing 10211. In this way, the synthesis cassette 101 can be conveniently fixed at the main synthesis unit 102. Therefore, mounting is fast, reliable, intuitive, and convenient, and replacement is easy.

It should be noted that, while the first common pipe 10111 is mounted at the front housing 10211, some functional members at the main synthesis unit 102 need to be correspondingly connected to relevant members of the synthesis cassette 101. For example, the rotary motor drive assembly 1022 and the linear motor drive assembly 1023 in the main synthesis unit frame 1021 need to be connected to the three-way valve 10112 and the piston of the syringe of the synthesis cassette 101, respectively.

In the full-automatic radiopharmaceutical production apparatus according to the embodiments of the present disclosure, the first common pipe 10111 of the synthesis cassette 101 is detachably fixed to the front housing 10211 of the main synthesis unit frame 1021 by the first fixing assembly 5, in such a manner that the synthesis cassette 101 can be conveniently fixed at the main synthesis unit 102. Therefore, mounting is fast, reliable, intuitive, and convenient, and replacement is easy.

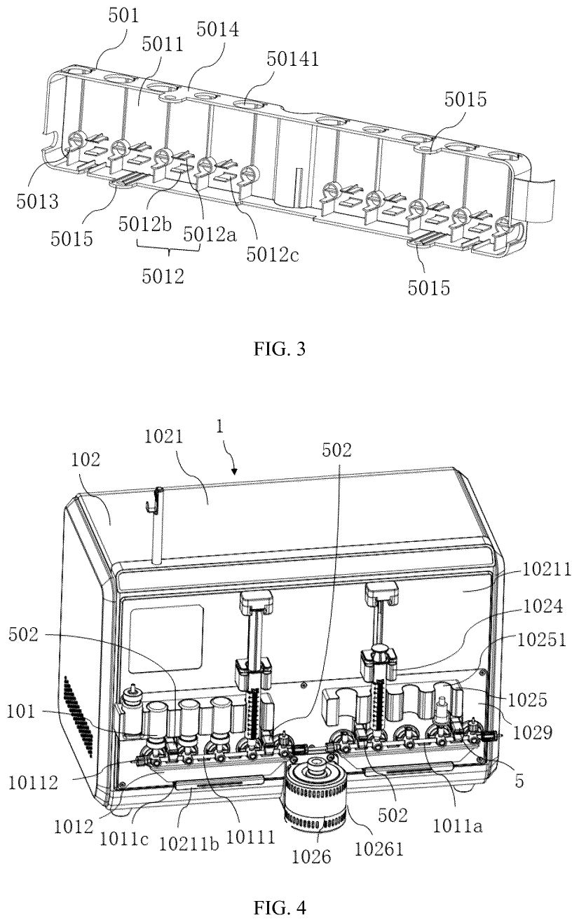

In some embodiments, the first fixing assembly 5 is one of a mounting sleeve 501 (as illustrated in FIG. 2 and FIG. 3), a snapping hook assembly 502 (as illustrated in FIG. 4, FIG. 8, and FIG. 10), and an engagement assembly (not illustrated in the figures). For example, the first fixing assembly 5 may be implemented as the mounting sleeve 501 as needed. When the mounting sleeve 501 is employed to fix the synthesis cassette 101 and the front housing 10211, the first common pipe 10111 of the synthesis cassette 101 may be detachably fixed at the mounting sleeve 501, and then the mounting sleeve 501 may be detachably fixed at the front housing 10211. In this way, the mounting is fast, reliable, intuitive, and convenient, and the replacement is easy. In addition, the mounting sleeve 501 provides protection for the synthesis cassette 101 and prevents radionuclides or other reactants from leaking out and causing contamination during the synthesis process. The first fixing assembly 5 may also be implemented as the snapping hook assembly 502 as needed. When the snapping hook assembly 502 is employed to fix the synthesis cassette 101 and the front housing 10211, the snapping hook assembly 502 may be pre-disposed at the front housing 10211. The synthesis cassette 101 can be fixed at the front housing 10211, as long as the first common pipe 10111 is engaged with and fixed to the snapping hook assembly 502. In this way, the mounting is fast, reliable, intuitive, and convenient, and the replacement is easy. Similarly, the first fixing assembly 5 may also be implemented as the engagement assembly (not illustrated in the figures) as needed. When the engagement assembly is employed to fix the synthesis cassette 101 and the front housing 10211, the engagement assembly may be pre-disposed at the front housing 10211. The entire synthesis cassette 101 can be fixed at the front housing 10211 through an engagement with the first common pipe 10111 directly realized by the engagement assembly. In this way, the mounting is fast, reliable, intuitive, and convenient, and replacement of the synthesis cassette 101 is easy.

In addition to the mounting sleeve 501, the snapping hook assembly 502, and the engagement assembly, other fixing assemblies that can directly fix the first common pipe 10111 to realize fixing the synthesis cassette 101 at the front housing 10211 fall within the scope of protection of the first fixing assembly 5 of the present disclosure.

In some embodiments, as illustrated in FIG. 2 and FIG. 3, the first common pipe 10111 is detachably engaged with and fixed at an inner side of the mounting sleeve 501, and the mounting sleeve 501 is detachably inserted into and fixed at the front housing 10211. That is, the first common pipe 10111 is engaged with and fixed at the inner side of the mounting sleeve 501, and the mounting sleeve 501 is directly inserted into the front housing 10211. In this way, the synthesis cassette 101 can be mounted and disassembled quickly, the mounting of the synthesis cassette 101 is fast, reliable, intuitive, and convenient, and the replacement of the synthesis cassette 101 is easy.

In some embodiments, the mounting sleeve 501 includes a vertical plate 5011 and an engagement base 5012. The vertical plate 5011 and the front housing 10211 face each other. The engagement base 5012 is fixed at a rear side surface of the vertical plate 5011. The first common pipe 10111 is engaged in the engagement base 5012. With the vertical plate 5011, on the one hand, support can be provided for the engagement base 5012, and on the other hand, protection can be provided for the synthesis cassette body 1011 at a rear side of the vertical plate 5011. With the engagement base 5012, mounting and disassembly of the first common pipe 10111 of the synthesis cassette body 1011 can be facilitated and realized quickly, and the replacement of the synthesis cassette 101 is easy.

In some embodiments, the engagement base 5012 includes an upper engagement base 5012a and a lower engagement base 5012b. The first common pipe 10111 is engaged between the upper engagement base 5012a and the lower engagement base 5012b. In this way, the synthesis cassette 101 can be mounted and disassembled quickly, the mounting of the synthesis cassette 101 is reliable, and the replacement of the synthesis cassette 101 is easy.

Preferably, each of surfaces of the upper engagement base 5012a and the lower engagement base 5012b facing each other has a recess 5012c. A top and a bottom of the first common pipe 10111 may be inserted into corresponding recesses 5012c, respectively. In this way, the mounting is reliable.

In some embodiments, the mounting sleeve 501 further includes a three-way valve support 5013. The three-way valve support 5013 is fixed at the rear side surface of the vertical plate 5011, and is configured to support a corresponding one of the three-way valves 10112 at the first common pipe 10111. By supporting the three-way valve 10112 at the first common pipe 10111 using the three-way valve support 5013, a load on the engagement base 5012 can be reduced to further stabilize the synthesis cassette 101, which prevents the synthesis cassette 101 and accessories associated with the synthesis cassette 101, such as containers or syringes, from shaking during the synthesis process.

In some embodiments, the mounting sleeve 501 further includes a surrounding wall 5014 located at a rear side of the vertical plate 5011. The surrounding wall 5014 has an end fixed to a periphery of the vertical plate 5011 and another end provided with a plurality of insertion portions 5015. The plurality of insertion portions 5015 are adaptively inserted into and fixed to the front housing 10211. With the surrounding wall 5014, on the one hand, the synthesis cassette body 1011 can be protected, and on the other hand, it facilitates the enhancement of overall strength of the mounting sleeve 501. By disposing the insertion portion 5015 at the surrounding wall 5014, detachable fixation of the mounting sleeve 501 at the front housing 10211 can be facilitated.

In some embodiments, the front housing 10211 is provided with a first support 10211a, and a bottom of the surrounding wall 5014 is supported on the first support 10211a. By disposing the first support 10211a at the front housing 10211, on the one hand, weights of the mounting sleeve 501, the synthesis cassette 101, and radiopharmaceuticals or the like in the synthesis cassette 101 during the radiopharmaceutical labeling and synthesis process can be prevented form concentrating on the insertion portion 5015 of the mounting sleeve 501, which is conducive to prolonging a service life of the mounting sleeve 501 and ensuring that the mounting sleeve 501 can be reliably fixed at the front housing 10211. On the other hand, during mounting of the mounting sleeve 501, the mounting sleeve 501 can be initially positioned by the first support 10211a, and is then pushed backwards to enable the insertion portion 5015 of the mounting sleeve 501 to be inserted into the front housing 10211, realizing reliable fixation and easy mounting and disassembly.

In some embodiments, a top of the surrounding wall 5014 has a plurality of through holes 50141 for passage of respective containers and respective tubes at the synthesis cassette body 1011. These through holes 50141 can allow for satisfactory positioning of the containers and the tubes at the synthesis cassette body 1011.

In some embodiments, as illustrated in FIG. 4, the snapping hook assembly 502 is disposed at the front housing 10211. The snapping hook assembly 502 is configured to hook and snap at the first common pipe 10111 in a front-rear direction. Therefore, the synthesis cassette 101 is detachably fixed at the front housing 10211. Mounting of the synthesis cassette 101 is fast, reliable, intuitive, and convenient, and replacement of the synthesis cassette 101 is easy.

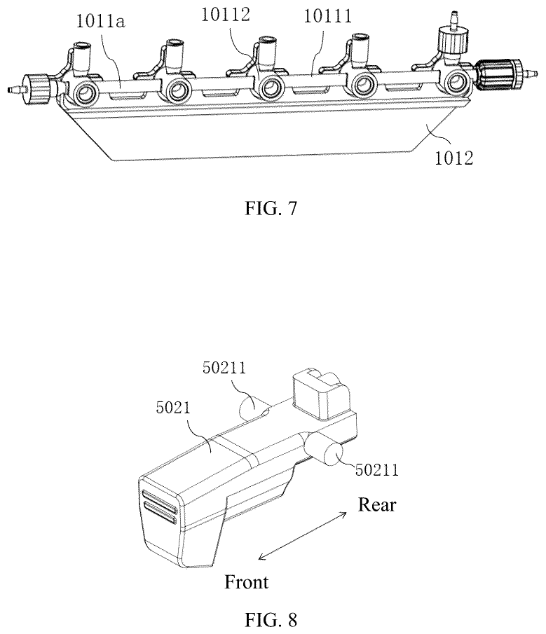

In some embodiments, as illustrated in FIG. 4, FIG. 7, and FIG. 8, the snapping hook assembly 502 includes a snapping hook 5021. The snapping hook 5021 includes a hook portion at a front end of the snapping hook 5021, and is located at an outer side (i.e., front side) of the front housing 10211. The hook portion is configured to hook and snap at the first common pipe 10111. Therefore, the synthesis cassette 101 is detachably fixed at the front housing 10211. The mounting of the synthesis cassette 101 is fast, reliable, intuitive, and convenient, and the replacement of the synthesis cassette 101 is easy.

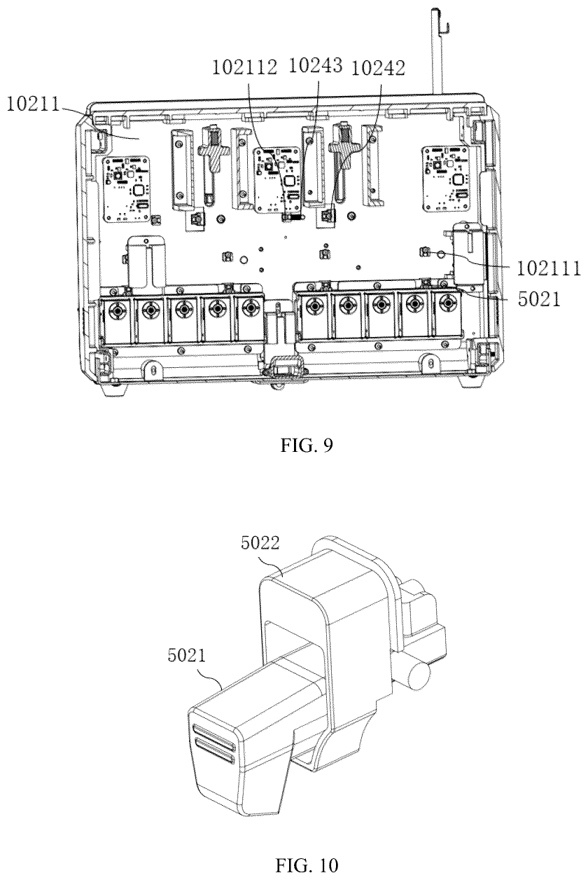

In some embodiments, as illustrated in FIG. 4, FIG. 8, and FIG. 9, the snapping hook assembly 502 further includes a first spring (not illustrated in the figures). The snapping hook 5021 passes through the front housing 10211 and is disposed on the front housing 10211 to be rotatable up and down about an axis. The first spring is vertically arranged at a rear side of the front housing 10211. The first spring has an end fixed at a first spring fixing block 102111 (see FIG. 9) at the front housing 10211 and another end fixed at a rear end of the snapping hook 5021. The first spring is configured to, by means of a restoring force of the first spring, enable the hook portion to hook and snap at the first common pipe 10111. During the mounting of the synthesis cassette 101, the hook portion is pushed to cause the snapping hook 5021 to rotate and drive the hook portion to rotate. The synthesis cassette body 1011 is placed at a mounting site of the front housing 10211. Then, the hook portion is made to hook and snap at the first common pipe 10111. The snapping hook 5021 is locked using the restoring force of the first spring. In this way, the synthesis cassette body can be reliably fixed at the front housing. The mounting of the synthesis cassette 101 is fast, reliable, intuitive, and convenient, and the replacement of the synthesis cassette 101 is easy.

In some embodiments, the hook portion faces downwards, and the restoring force of the first spring acts vertically upwards. During the mounting of the synthesis cassette 101, the hook portion is pushed upwards to cause the snapping hook 5021 to rotate and drive the hook portion to rotate upwards. The synthesis cassette body 1011 is placed at the mounting site of the front housing 10211. Then, the hook portion is made to hook and snap at the first common pipe 10111. The snapping hook 5021 is locked using the restoring force of the first spring. In this way, the synthesis cassette body can be reliably fixed at the front housing. The mounting of the synthesis cassette 101 is fast, reliable, intuitive, and convenient, and the replacement of the synthesis cassette 101 is easy.

In some embodiments, as illustrated in FIG. 8, the snapping hook 5021 is provided with coaxial rotation shafts 50211 at a left side and a right side of the snapping hook 5021, respectively. Each of the rotation shafts 50211 is rotatably mounted at an inner side of the front housing 10211. In this way, the snapping hook 5021 is rotatable up and down about an axis.

In some embodiments, as illustrated in FIG. 10, the snapping hook assembly 502 further includes a protective sleeve 5022. The protective sleeve 5022 is fixed at a front side of the front housing 10211. The protective sleeve 5022 has a space for the snapping hook 5021 to rotate up and down. The snapping hook 5021 is located in the space. The hook portion extends out of the protective sleeve 5022. With the protective sleeve 5022, on the one hand, the snapping hook 5021 can be protected. On the other hand, a rotation of the snapping hook 5021 can be limited to avoid an excessive rotation of the snapping hook 5021.

In some embodiments, the synthesis cassette body 1011 further includes a foundation base 1012 (as illustrated in FIG. 4 and FIG. 7) located below the synthesis cassette body 1011. The foundation base 1012 and the synthesis cassette body 1011 may be integrally formed or may be detachably mounted and fixed to each other. The synthesis cassette body 1011 is fixed at the foundation base 1012. The front housing 10211 is provided with a second support 10211b (as illustrated in FIG. 6). The foundation base 1012 is supported on the second support 10211b (as illustrated in FIG. 4). By disposing the second support 10211b at the front housing 10211, on the one hand, weights of the synthesis cassette 101 and the radiopharmaceutical or the like in the synthesis cassette 101 during the radiopharmaceutical labeling and synthesis process are prevented from concentrating on the snapping hook assembly 502, in such a manner that most of the weights of the synthesis cassette 101 and the radiopharmaceutical or the like in the synthesis cassette 101 during the radiopharmaceutical labeling and synthesis process are concentrated on the second support 10211b, which provides load bearing and is conducive to prolonging a service life of the snapping hook assembly 502. On the other hand, the foundation base 1012 of the synthesis cassette 101 can be positioned by the second support 10211b, and the first common pipe 10111 can be fixed by the snapping hook 5021.

In some embodiments, as illustrated in FIG. 4 and FIG. 6, a top of the second support 10211b has an engagement groove 10211c. A lower end of the foundation base 1012 is engaged in the engagement groove 10211c. In this way, reliable positioning is realized.

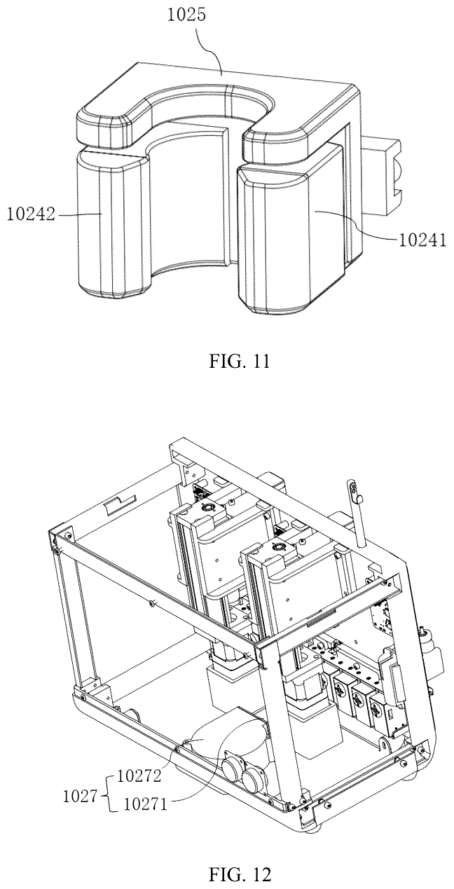

In some embodiments, as illustrated in FIG. 4, FIG. 6, and FIG. 11, the main synthesis unit 102 further includes a barrel fixing module 1024. The barrel fixing module 1024 is disposed at the front housing 10211 and includes a first engagement block 10241 and a second engagement block 10242 that are arranged to face each other in the left-right direction. A distance between the first engagement block 10241 and the second engagement block 10242 is adjustable. The first engagement block 10241 and the second engagement block 10242 are configured to tightly clamp a barrel of a syringe at the synthesis cassette body 1011. The barrel of the syringe is easily and reliably fixed and easily disassembled. In some embodiments, as illustrated in FIG. 4, FIG. 6, FIG. 9, and FIG. 11, the barrel fixing module 1024 further includes a second spring 10243. The first engagement block is fixed at the front housing 10211. The second engagement block is arranged at the front housing 10211 to be movable in the left-right direction. Each of an engagement portion of the first engagement block 10241 and an engagement portion of the second engagement block 10242 is located at a front side of the front housing 10211. The second spring 10243 has an end connected to the second engagement block 10242 and another end fixed to a second spring fixing block 102112 at the front housing 10211. The second spring 10243 is configured to, by means of a restoring force of the second spring 10243, enable the engagement portion of the second engagement block 10242 and the engagement portion of the first engagement block 10241 to tightly clamp the barrel of the syringe at the synthesis cassette body 1011. During fixing the barrel of the syringe using the barrel fixing module 1024, it is sufficient to push away the second engagement block 10242, place the barrel of the syringe at the mounting site, and then release the second engagement block 10242. The engagement portion of the second engagement block 10242 and the engagement portion of the first engagement block 10241 can reliably clamp the barrel of the syringe under an action of the restoring force of the second spring 10243. As a result, the barrel of the syringe is easily and reliably fixed and easily disassembled.

In some embodiments, as illustrated in FIG. 4 and FIG. 6, the main synthesis unit 102 further includes a container fixing module 1025 disposed at the front housing 10211 and having a plurality of fixing cavities 10251. The plurality of fixing cavities 10251 are configured to correspondingly accommodate a barrel of a syringe and a container at the synthesis cassette body 1011. The plurality of fixing cavities 10251 are integrally formed or arranged at intervals in the left-right direction. In this way, mounting and disassembly of the barrel of the syringe and the container are easy.

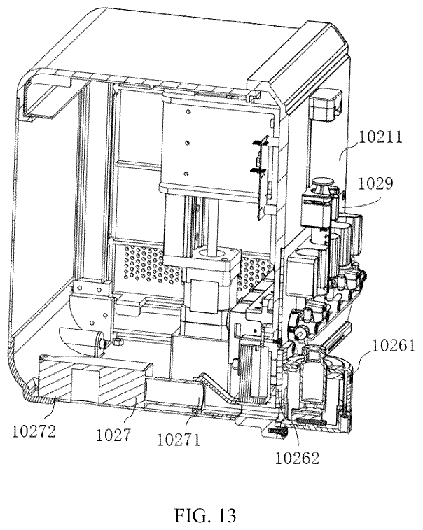

In some embodiments, as illustrated in FIG. 4, FIG. 6, and FIG. 13, the main synthesis unit 102 further includes a heating system 1026. The heating system 1026 includes a heater 10261 and a heat insulation plate 10262. The heater 10261 is fixed at a front side of the front housing 10211. The heat insulation plate 10262 is arranged between the front housing 10211 and the heater 10261. It should be understood that the heater 10261 can rapidly increase a temperature to heat the container in the synthesis cassette 101 containing a to-be-heated reaction liquid to rapidly synthesize radiopharmaceuticals. By arranging the heat insulation plate 10262 between the front housing 10211 and the heater 10261, heat generated by the heater 10261 can be prevented from being transferred to the front housing 10211. In this way, temperatures of containers and syringes at the front housing 10211 other than the container in the heater 10261 are prevented from being affected, which is conducive to normal progress of the radiopharmaceutical labeling and synthesis process. Further, a heat loss is prevented, which facilitates temperature control of the heater.

In some embodiments, the heat insulation plate 10262 has a thickness ranging from 1 mm to 10 mm, which provides satisfactory heat insulation. Preferably, the thickness ranges from 2 mm to 6 mm, which provides better heat insulation. Most preferably, the thickness ranges from 2 mm to 3 mm, which provides optimal heat insulation.

In some embodiments, as illustrated in FIG. 12 and FIG. 13, the main synthesis unit 102 further includes a heat dissipation system 1027. The heat dissipation system 1027 has a heat dissipation channel 10271 and includes a heat dissipation device 10272. The heat dissipation channel 10271 and the heat dissipation device 10272 are disposed in the main synthesis unit frame 1021. The heat dissipation channel 10271 has an end connected to the heater 10261 and another end connected to the heat dissipation device 10272. The heat dissipation channel 10271 is made of a heat-insulating material, while the heat dissipation device 10272 may be a heat dissipation fan. With the heat dissipation channel 10271 and the heat dissipation device 10272, the heater 10261 can be rapidly cooled down, and heat of the heater 10261 can be transferred to an external environment through the heat dissipation channel 10271 and the heat dissipation device 10272 to prevent the heat of the heater 10261 from being transferred to the front housing 10211. In this way, the temperatures of the containers and the syringes at the front housing 10211 other than the container in the heater 10261 are prevented from being affected, which is conducive to the normal progress of the radiopharmaceutical labeling and synthesis process.

Preferably, the heat dissipation channel 10271 and the heat dissipation device 10272 may be disposed at an inner side of the bottom plate of the main synthesis unit frame 1021.

It should be noted that the above heat dissipation system 1027 may also be replaced with a water-cooled structure or an electronic cooling structure.

In some embodiments, as illustrated in FIG. 5, the main synthesis unit 102 further includes a radioactive probe 1028 fixed at a rear side of the front housing 10211. The radioactive probe 1028 is selectively arranged to face a container or a syringe at the synthesis cassette body 1011 in a front-rear direction. In this way, changes in radioactivity in the corresponding container can be conveniently detected by the radioactive probe 1028. The radioactive probe 1028 is connected to an automated operation software. A radioactivity value can be displayed by the automated operation software, and thus an operator can conveniently and quickly determine a reaction process based on the radioactivity value.

In some embodiments, a distance between the radioactive probe 1028 and the container or the syringe ranges from 1 mm to 100 mm. Preferably, the distance ranges from 10 mm to 60 mm. Most preferably, the distance ranges from 20 mm to 40 mm.

In some embodiments, as illustrated in FIG. 2, FIG. 4, and FIG. 13, the main synthesis unit 102 further includes an anti-corrosion surface 1029. The anti-corrosion surface 1029 is disposed at a front surface of the front housing 10211. The anti-corrosion surface 1029 is located between the front housing 10211 and the synthesis cassette 101. It should be understood that by arranging the anti-corrosion surface 1029 between the front housing 10211 and the synthesis cassette 101, a radiopharmaceutical liquid in the container, tube, or the like at the synthesis cassette 101 can be prevented from spilling or overflowing and spilling onto the front housing 10211 to avoid corrosion of the front housing 10211, maintaining an aesthetically favorable overall appearance. The anti-corrosion surface 1029 may be a Teflon plate that can be fixed to the front housing 10211 through a screw, which is easy to be replaced after being damaged, and the operation for the replacement is convenient. The anti-corrosion surface 1029 may also be an anti-corrosion film, which is easy to be replaced after being damaged, and the operation for the replacement is convenient.

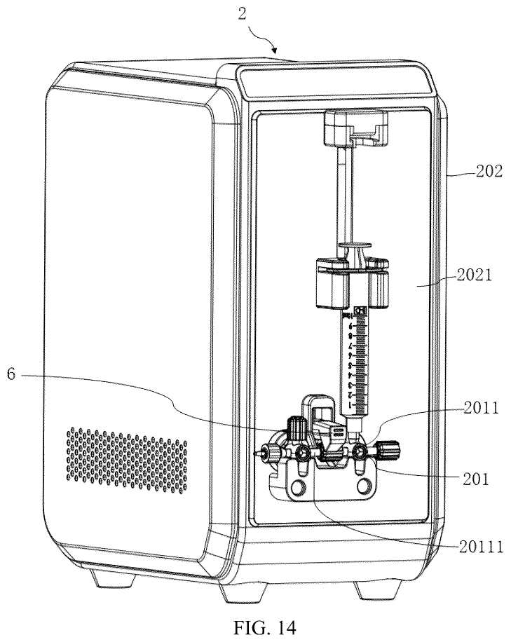

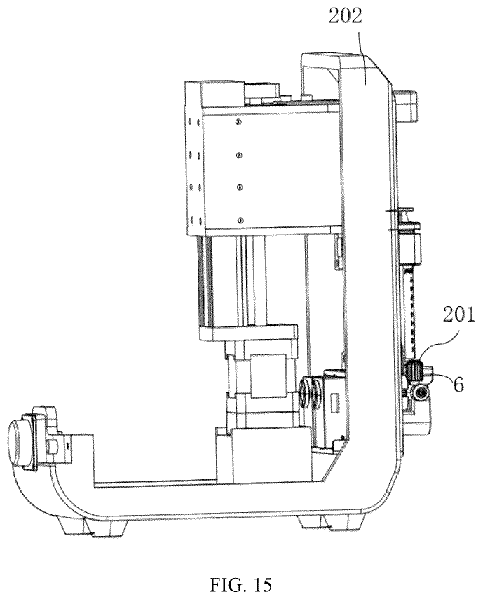

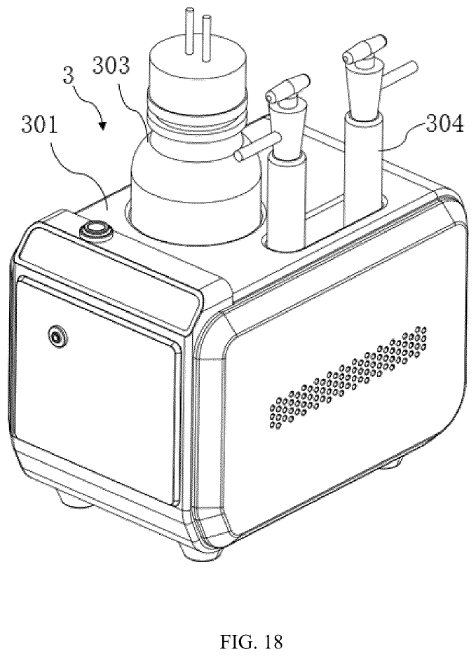

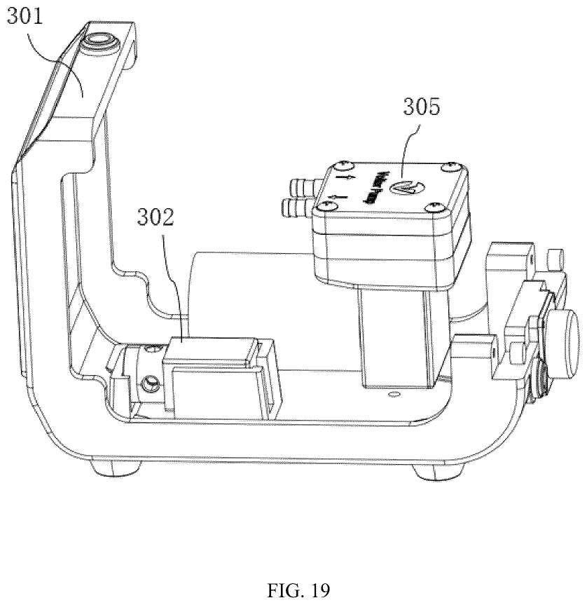

In some embodiments, at least one of a purification device 2 (as illustrated in FIG. 14 to FIG. 17) or a waste gas treatment device 3 (as illustrated in FIG. 18 and FIG. 19) are also included. It should be understood that the purification device 2 is independent of the synthesis device 1 and may be used in combination with the synthesis device 1. For example, the purification device 2 may be used selectively based on the radiopharmaceutical synthesis process. If the radiopharmaceutical synthesis process can be completed in the synthesis device 1, it is unnecessary to purchase the purification device 2 separately, reducing costs of the apparatus. If the radiopharmaceutical synthesis process cannot be completed in the synthesis device 1 and a synthesized radiopharmaceutical produced by the synthesis device 1 needs further purification, a purification cassette 201 of the purification device 2 is connected to the synthesis cassette 101 of the synthesis device 1, in such a manner that the synthesized radiopharmaceutical produced by the synthesis device 1 is transferred to the purification device 2 for a purification treatment to obtain the ultimately required qualified radiopharmaceutical. It should be noted that the purification device 2 can not only carry out the purification treatment, but also cooperate with a germanium-gallium generator to elute ⁶⁸Ga nuclides or the like. In this case, a purification column can be removed. The waste gas treatment device 3 is independent of the synthesis device 1, and can be used in combination with the synthesis device 1. When the radiopharmaceutical in the synthesis device 1 undergoes a synthesis reaction, a predetermined amount of hazardous gas is usually generated, and thus the waste gas treatment device 3 is required to be used in combination with the synthesis device 1 to remove the hazardous gas.

That is, for the full-automatic radiopharmaceutical production apparatus, the synthesis device 1 can be used alone, connected to the purification device 2, connected to the waste gas treatment device 3, or connected to both the purification device 2 and the waste gas treatment device 3 based on needs of the radiopharmaceutical synthesis process to meet experimental needs of different nuclides.

In some embodiments, as illustrated in FIG. 14 to FIG. 17, the purification device 2 includes the purification cassette 201. The purification cassette 201 includes a purification cassette body 2011 and a main purification unit 202. The purification cassette body 2011 can be understood as a purification system N in FIG. 1 and is a main component of the purification cassette. The purification cassette body 2011 and the synthesis cassette body 1011 are detachably connected to receive the radiopharmaceutical produced by the synthesis device 1. The purification cassette body 2011 includes a second common pipe 20111 extending in the left-right direction. The main purification unit 202 is independently provided and includes a main purification unit frame 2021. The second common pipe 20111 is detachably fixed at the main purification unit frame 2021 by a second fixing assembly 6. It should be understood that, similar to the synthesis cassette body 1011, the purification cassette body 2011 is composed of the multi-linked three-way module, the syringe, the container (e.g., the purification column), and the tube, and that the second common pipe 20111 refers to a pipe connected between three-way valves that are adjacent in the multi-linked three-way module of the purification cassette body 2011. A manner of connecting the purification cassette 201 and the main purification unit 202 in the purification device 2 is substantially similar to that of connecting the synthesis cassette 101 and the main synthesis unit 102 in the synthesis device 1. A structure adopted for the second fixing assembly 6 may be a structure adopted in the first fixing assembly 5, and thus details thereof will be omitted here.

In some embodiments, as illustrated in FIG. 18 and FIG. 19, the waste gas treatment device 3 includes a waste gas treatment device frame 301, a three-way solenoid valve 302, a washing bottle 303, a U-shaped tube 304, and a vacuum pump 305. The waste gas treatment device frame 301 is independently provided. That is, the waste gas treatment device frame 301 and the main synthesis unit frame 1021 are not connected to each other. The three-way solenoid valve 302, the washing bottle 303, the U-shaped tube 304, and the vacuum pump 305 constitute a waste gas treatment system L in FIG. 1. Each of the three-way solenoid valve 302, the washing bottle 303, the U-shaped tube 304, and the vacuum pump 305 is mounted in the waste gas treatment device frame 301. The three-way solenoid valve 302 has an end detachably connected to an outlet pipe of a waste gas bottle of the synthesis cassette body 1011. When the hazardous gas generated by the synthesis device 1 needs to be treated, the end of the three-way solenoid valve 302 may be connected to the outlet pipe of the waste gas bottle of the synthesis cassette body 1011, in such a manner that the hazardous gas generated in the synthesis device 1 can be transferred into the waste gas treatment device 3 for a waste gas treatment. When no waste gas treatment is required, the three-way solenoid valve 302 may be disconnected from the outlet pipe of the waste gas bottle of the synthesis cassette body 1011. The three-way solenoid valve 302 has another end connected to the washing bottle 303. The U-shaped tube 304 has an end connected to the washing bottle 303 and another end connected to the vacuum pump 305.

Waste gas treatment principle is as follows. The washing bottle 303 is filled with sodium hydroxide or other alkaline solution, which reacts with, absorbs, and removes the generated waste gas (a hydrogen chloride gas). The U-shaped tube 304 connected rearwards is filled with activated carbon and phosphorus pentoxide. A large number of molecules at a pore wall of the activated carbon can create a strong attractive force to attract impurities in a medium to the pores. In addition to physical adsorption, chemical reactions also often occur at a surface of the activated carbon. The activated carbon not only contains carbon, but also contains small amounts of oxygen and hydrogen in a form of chemically bonded functional groups at the surface of the activated carbon, such as carboxyl groups, hydroxyl groups, phenols, lactones, quinones, and ethers. These oxides or complexes contained at the surface can react chemically with adsorbed substances, and thus combine with the adsorbed substances to aggregate at the surface of the activated carbon. Phosphorus pentoxide is hygroscopic and can be used as a desiccant. A waste gas may be generated during the reaction. When the vacuum pump 305 is activated, a negative pressure is created between an internal pipe of the waste gas system and air in an ambient environment. The negative pressure draws the generated waste gas to pass through the washing bottle 303 to the U-shaped tube 304. After undergoing many times of filtration, the waste gas is completely removed.

Reference throughout this specification to “an embodiment”, “some embodiments”, “illustrative embodiments”, “an example”, “a specific example”, or “some examples” means that a particular feature, structure, or characteristic described in connection with the embodiment or example is included in at least one embodiment or example of the present disclosure. The appearances of the above phrases in various places throughout this specification are not necessarily referring to the same embodiment or example. Further, the particular features, structures, or characteristics may be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. A full-automatic radiopharmaceutical production apparatus comprising a synthesis device, the synthesis device comprising:
a synthesis cassette comprising a synthesis cassette body, the synthesis cassette body comprising a first common pipe extending in a left-right direction, the first common pipe being located between three-way valves that are adjacent in the left-right direction; and
a main synthesis unit comprising a main synthesis unit frame, the first common pipe being detachably fixed at a front housing of the main synthesis unit frame by a first fixing assembly.

2. The full-automatic radiopharmaceutical production apparatus according to claim 1, wherein the first fixing assembly is one of a mounting sleeve, a snapping hook assembly, and an engagement assembly.

3. The full-automatic radiopharmaceutical production apparatus according to claim 2, wherein:
the first fixing assembly is the mounting sleeve, the first common pipe is detachably engaged with and fixed at an inner side of the mounting sleeve; and
the mounting sleeve is detachably inserted into and fixed at the front housing.

4. The full-automatic radiopharmaceutical production apparatus according to claim 3, wherein the mounting sleeve comprises:
a vertical plate, the vertical plate and the front housing facing each other; and
an engagement base fixed at a rear side surface of the vertical plate, the first common pipe being engaged in the engagement base.

5. The full-automatic radiopharmaceutical production apparatus according to claim 4, wherein the engagement base comprises an upper engagement base and a lower engagement base, the first common pipe being engaged between the upper engagement base and the lower engagement base.

6. The full-automatic radiopharmaceutical production apparatus according to claim 4, wherein the mounting sleeve further comprises:
a three-way valve support fixed at the rear side surface of the vertical plate, the three-way valve support being configured to support a corresponding one of the three-way valves at the first common pipe.

7. The full-automatic radiopharmaceutical production apparatus according to claim 5, wherein the mounting sleeve further comprises:
a surrounding wall located at a rear side of the vertical plate, the surrounding wall having an end fixed to a periphery of the vertical plate and another end provided with a plurality of insertion portions, the plurality of insertion portions being adaptively inserted into and fixed to the front housing.

8. The full-automatic radiopharmaceutical production apparatus according to claim 7, wherein the front housing is provided with a first support, a bottom of the surrounding wall being supported on the first support.

9. The full-automatic radiopharmaceutical production apparatus according to claim 7, wherein a top of the surrounding wall has a plurality of through holes for passage of respective containers and respective tubes at the synthesis cassette body.

10. The full-automatic radiopharmaceutical production apparatus according to claim 2, wherein the first fixing assembly is the snapping hook assembly, the snapping hook assembly is disposed at the front housing and configured to hook and snap at the first common pipe in a front-rear direction.

11. The full-automatic radiopharmaceutical production apparatus according to claim 10, wherein the snapping hook assembly comprises a snapping hook located at an outer side of the front housing, the snapping hook comprising a hook portion at a front end of the snapping hook, the hook portion being configured to hook and snap at the first common pipe.

12. The full-automatic radiopharmaceutical production apparatus according to claim 11, wherein:
the snapping hook assembly further comprises a first spring vertically arranged at a rear side of the front housing, the first spring having an end fixed at the front housing and another end fixed at a rear end of the snapping hook, and the first spring being configured to, by means of a restoring force of the first spring, enable the hook portion to hook and snap at the first common pipe; and
the snapping hook passes through the front housing and is disposed on the front housing to be rotatable up and down about an axis,
wherein the snapping hook is provided with coaxial rotation shafts at a left side and a right side of the snapping hook, respectively, each of the rotation shafts being rotatably mounted at an inner side of the front housing.

13. The full-automatic radiopharmaceutical production apparatus according to claim 12, wherein the snapping hook assembly further comprises:
a protective sleeve fixed at a front side of the front housing, the protective sleeve having a space for the snapping hook to rotate up and down, the snapping hook being located in the space, and the hook portion extending out of the protective sleeve.

14. The full-automatic radiopharmaceutical production apparatus according to claim 10, wherein:
the synthesis cassette body further comprises a foundation base located below the synthesis cassette body, the synthesis cassette body being fixed at the foundation base; and
the front housing is provided with a second support, the foundation base being supported on the second support,
preferably, a top of the second support has an engagement groove, a lower end of the foundation base being engaged in the engagement groove.

15. The full-automatic radiopharmaceutical production apparatus according to claim 2, wherein the main synthesis unit further comprises:
a barrel fixing module disposed at the front housing and comprising a first engagement block and a second engagement block, the first engagement block and the second engagement block being arranged to face each other in the left-right direction and configured to tightly clamp a barrel of a syringe at the synthesis cassette body, and a distance between the first engagement block and the second engagement block being adjustable.

16. The full-automatic radiopharmaceutical production apparatus according to claim 15, wherein the barrel fixing module further comprises a second spring, wherein:
the first engagement block is fixed at the front housing;
the second engagement block is arranged at the front housing to be movable in the left-right direction;
each of an engagement portion of the first engagement block and an engagement portion of the second engagement block is located at a front side of the front housing; and
the second spring has an end connected to the second engagement block and another end fixed to the front housing, the second spring being configured to, by means of a restoring force of the second spring, enable the engagement portion of the second engagement block and the engagement portion of the first engagement block to tightly clamp the barrel of the syringe at the synthesis cassette body.

17. The full-automatic radiopharmaceutical production apparatus according to claim 2, wherein the main synthesis unit further comprises:
a container fixing module disposed at the front housing and having a plurality of fixing cavities, the plurality of fixing cavities being configured to correspondingly accommodate a barrel of a syringe and a container at the synthesis cassette body.

18. The full-automatic radiopharmaceutical production apparatus according to claim 1, wherein the main synthesis unit further comprises:
a heating system comprising a heater and a heat insulation plate, the heater being fixed at a front side of the front housing, and the heat insulation plate being arranged between the front housing and the heater,
preferably, the main synthesis unit further comprises:
a heat dissipation system having a heat dissipation channel and comprising a heat dissipation device, the heat dissipation channel and the heat dissipation device being disposed in the main synthesis unit frame, and the heat dissipation channel having an end connected to the heater and another end connected to the heat dissipation device.

19. The full-automatic radiopharmaceutical production apparatus according to claim 1, further comprising at least one of a purification device or a waste gas treatment device.

20. The full-automatic radiopharmaceutical production apparatus according to claim 19, wherein the purification device comprises:
a purification cassette body comprising a second common pipe extending in the left-right direction, wherein the purification cassette body and the synthesis cassette body are detachably connected to receive a radiopharmaceutical produced by the synthesis device; and
a main purification unit independently provided and comprising a main purification unit frame, the second common pipe being detachably fixed at the main purification unit frame by a second fixing assembly,
the waste gas treatment device comprises a waste gas treatment device frame, a three-way solenoid valve, a washing bottle, a U-shaped tube, and a vacuum pump, wherein:
the waste gas treatment device frame is independently provided;
each of the three-way solenoid valve, the washing bottle, the U-shaped tube, and the vacuum pump is mounted in the waste gas treatment device frame;
the three-way solenoid valve has an end detachably connected to an outlet pipe of a waste gas bottle of the synthesis cassette body and another end connected to the washing bottle; and
the U-shaped tube has an end connected to the washing bottle and another end connected to the vacuum pump.
